(19) United States
(12) Patent Application Publication
(10) Pub. No.: US 2024/0428115 A1
(43) Pub. Date: Dec. 26, 2024

(54) CONTROLLING QUANTUM COMPUTING SYSTEM TO DETERMINE QUANTITY OF OBJECT

(71) Applicant: Goldman Sachs & Co. LLC, New York, NY (US)

(72) Inventors: Nikitas Stamatopoulos, New York, NY (US); William Joesph Zeng, New York, NY (US)

(21) Appl. No.: 18/742,960

(22) Filed: Jun. 13, 2024

Related U.S. Application Data
(60) Provisional application No. 63/522,277, filed on Jun. 21, 2023.

(30) Foreign Application Priority Data
Jun. 14, 2023 (GR) 20230100473

(51) Int. Cl. G06N 10/60; G06N 10/40

(52) U.S. Cl. CPC G06N 10/60; G06N 10/40

(57) ABSTRACT

A system may receive a function ƒ(x) describing a value of an object, values of x, and probabilities p(x) for the values of x. The system may determine a quantum operator U₊^{\vec{ϕ}} that, when executed by a quantum computing system, encodes an approximation of the function ƒ(x) in an amplitude of a quantum state without calculating |ƒ(x) [symbol] for any of the values of x. The system may instruct the quantum computing system to execute quantum operators (including U₊^{\vec{ϕ}}) to generate a quantum state on a register of qubits, where one of the amplitudes of the generated quantum state includes probabilities p(x) for the values of x and output values of the approximation of the function ƒ(x) for the values of x. The system may determine the value of the object based on the generated quantum state.

### CROSS-REFERENCE TO RELATED APPLICATIONS

This application claims priority to, and the benefit of, U.S. Provisional Patent Application Ser. No. 63/522,277 “Derivative Pricing using Quantum Signal Processing” filed Jun. 21, 2023 and Greek patent application No. 20230100473 filed on Jun. 14, 2023, each of which are incorporated by reference in their entirety.

### BACKGROUND

### 1. Technical Field

This disclosure relates generally to controlling quantum computing systems, and more particularly, to controlling quantum computing systems to determine quantities of objects.

### 2. Description of Related Art

Quantum computing systems can be controlled to determine quantities of objects with stochastic behaviors (e.g., pricing of financial derivatives) using Amplitude Estimation (AE). These control methods may provide a quadratic speedup compared to traditional classical Monte Carlo methods. However, the estimated resources required for the quantum circuits of these control methods are considerably higher than what is possible with current and near-term quantum computing devices. Thus, there is a desire to determine new control methods that use fewer quantum resources.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is an example circuit diagram of the quantum operator U₊^{\vec{ϕ}} of Eq. (9).

FIG. 2A is an example plot of the function ƒ(x) of Eq. (30).

FIG. 2B is an example plot of the absolute error between ƒ(x) (from FIG. 2A) and an approximation G(x).

FIG. 3 is a flowchart of an example method for controlling a quantum computing system to determine the value of an object.

FIGS. 4A-4B are block diagrams of an example computing system including a classical computing system and a quantum computing system.

FIG. 4C-4D are block diagrams of example components of a quantum computing system.

FIG. 4E is a flow chart that illustrates an example execution of a quantum routine on the computing system.

FIG. 5 is an example architecture of a classical computing system.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### INTRODUCTION

This disclosure describes controlling quantum computing systems to determine quantities of objects (e.g., quantities that change stochastically). These new techniques use fewer quantum computational resources than conventional techniques. Among other advantages, these new techniques may reduce computational resources by determining quantum operators that enable use of Quantum Signal Processing (QSP) techniques to determine the quantity of an object (e.g., the value of a product). For ease of explanation, the below descriptions describe controlling quantum computing systems in the context of determining pricing for financial derivatives. However, embodiments are not limited to this example use case. For example, the techniques described herein can also be used to control quantum computing systems to determine initial states for differential equations, quantum simulations of field theories and finite element analysis.

In a quantum setting, the quantum circuits which drive the pricing process of a financial derivate may include two components: 1) loading the probability distribution over paths of the stochastic variables involved in the calculation and 2) encoding the payoff of each path into the amplitude of an ancilla qubit. The first component can be represented by an operator [symbol] (also “P”) which, given stochastic paths ω∈Ω where each path occurs with probability p(ω), it prepares a probability-weighted superposition of all paths

$$𝒫 : \vert \vec{0} 〉 \to {\sum }_{ω} \sqrt{p ( ω )} \vert ω 〉 . \qquad ( 1 )$$

The second component is an operator [symbol] which computes the discounted payoff ƒ(ω) of the derivative on each path |ω [symbol] , and encodes that value in the amplitude of an ancilla qubit

$$ℱ : \vert ω 〉 \vert 0 〉 \to \vert ω 〉 \vert f ( ω ) 〉 ( \sqrt{f ( ω )} \vert 0 〉 + \sqrt{1 - f ( ω )} \vert 1 〉 ) . \qquad ( 2 )$$

The operator [symbol] =

[symbol]

$$𝒜 : \vert \vec{0} 〉 \vert 0 〉 \to ( {\sum }_{ω} \sqrt{p ( ω )} \sqrt{f ( ω )} \vert ω 〉 \vert f ( ω ) 〉 \vert 0 〉 + {\sum }_{ω} \sqrt{p ( ω )} \sqrt{1 - f ( ω )} \vert ω 〉 \vert f ( ω ) 〉 \vert 1 〉 ) , \qquad ( 3 )$$

creates a state such that the probability of measuring |0 [symbol] in the last qubit is the price of the derivative, represented as the expected value of the discounted payoff, [symbol] [ƒ]=Σ_{ω∈Ω}p(ω)ƒ(ω) (which may be determined by performing amplitude estimation).

However, the implementation of the [symbol] operator in Eq. (2) requires binary quantum arithmetic to compute a digital representation of the payoff |ƒ(ω) [symbol] from a path |ω [symbol] , before that value is encoded into the amplitude of the last qubit (use of “last,” “final” or “target” to refer to a qubit herein is used for merely for convenience to reference a specific qubit. A “last,” “final” or “target” qubit is not required to be last or final relative to other qubits (e.g., it is not required to be the last or final qubit on a quantum register)). In order to avoid the costly quantum arithmetic of this process, this disclosure shows (among other things) how to determine a quantum operator U₊^{\vec{ϕ}} (alternative to [symbol] ) using Quantum Signal Processing to generate a quantum state with the value \sqrt{ƒ(ω)} directly in the amplitude of an ancilla qubit, which significantly reduces the total resources used. More specifically, this disclosure enables preparation of the following state:

$$\vert \vec{0} 〉 \vert 0 〉 \to ( {\sum }_{ω} \sqrt{p ( ω )} \sqrt{f ( ω )} \vert ω 〉 \vert 0 〉 + {\sum }_{ω} \sqrt{p ( ω )} \sqrt{1 - f ( ω )} \vert ω 〉 \vert 1 〉 ) .$$

### Overview

Given an n-bit register |x [symbol] ₙ, and a unitary quantum operator U which creates the state (note that ω from the previous descriptions is replaced with x)

$${{{{{U \vert x 〉}_{n} \vert 0 〉}_{n + 1} = \vert x 〉}_{n} ( \sqrt{x} \vert {ψ}_{0} 〉}_{n} \vert 0 〉 + \sqrt{1 - x} \vert {ψ}_{1} 〉}_{n} \vert 1 〉 ) , \qquad ( 4 )$$

where |ψ₀ [symbol] ₙ and |ψ₁ [symbol] ₙ are normalized quantum states, the goal is to generate a unitary quantum operator U₊^{\vec{ϕ}} that prepares the state

$${{{{{{{\vert x 〉}_{n} \vert 0 〉}_{n + a} \to \vert x 〉}_{n} ( \sqrt{\frac{A {e}^{x} - B}{c}} \vert {ψ}_{0}^{l} 〉}_{n} \vert 0 〉}_{a} + \sqrt{1 - \frac{A {e}^{x} - B}{C}} \vert {ψ}_{1}^{′} 〉}_{n} \vert {0}_{⊥} 〉}_{a} ) , \qquad ( 5 )$$

for normalized quantum states |ψ₀′ [symbol] ₙ, |ψ₁′ [symbol] ₙ, and |0_{⊥} [symbol] ₐ denoting a normalized state orthogonal to |0 [symbol] ₐ. A, B, C are constants such that (Ae^{x}−B)/C∈[0,1]. To prepare the unitary quantum operator of Eqn. (5), aspects from Quantum Signal Processing may be used as further described below. Quantum Signal Processing is also generally described below in the section titled “Quantum Signal Processing.”

Defining projectors \tilde{Π}≡ [symbol] ^{⊗2n}⊗|0 [symbol] [symbol] 0| and Π≡ [symbol] ^{⊗n}⊗(0 [symbol] [symbol] 0|)^{⊗n+1}, observe that \tilde{Π}UΠ is a rank-1 matrix with a single non-trivial singular value \sqrt{x}. Consecutive invocations of U and U^{†}, interleaved with projector-controlled rotation operators Π_{ϕ}= [symbol] and \tilde{Π}_{ϕ}= [symbol] , enables applications of polynomial transformations to this singular value, using the Quantum Signal Processing framework. Given phase factors \vec{ϕ}=(ϕ₁, ϕ₂, . . . , ϕ_{d}), define

$${U}^{\vec{ϕ}} = \{ \begin{matrix}{\tilde{\prod }}_{{ϕ}_{1}} U {\prod }_{k = 1}^{( d - 1 ) / 2} {\prod }_{{ϕ}_{2 k}} {U}^{†} {\tilde{\prod }}_{{ϕ}_{2 k + 1}} U , & for odd d , \\ {\prod }_{k = 1}^{d / 2} {\prod }_{{ϕ}_{2 k - 1}} {U}^{†} {\tilde{\prod }}_{{ϕ}_{2 k}} U , & for even d\end{matrix} \qquad ( 6 )$$

$${U}_{C}^{\vec{ϕ}} = ( {U}^{\vec{ϕ}} ⊗ \vert 0 〉 〈 0 \vert + {U}^{- \vec{ϕ}} ⊗ \vert 1 〉 〈 1 \vert ) . \qquad ( 7 )$$

Then, for any polynomial G satisfying deg(G)≤d, |G(a)|≤1, ∀a∈[−1,1], and G either even or odd, there exist phase factors \vec{ϕ} such that the unitary

$${U}_{+}^{\vec{ϕ}} = ( {⊗ 2 n + 1}^{} ⊗ H ) {U}_{C}^{\vec{ϕ}} ( {⊗ 2 n + 1}^{} ⊗ H ) , \qquad ( 8 )$$

creates the state

$${{{{U}_{+}^{\vec{ϕ}} \vert x 〉}_{n} \vert 0 〉}_{n + 1} \vert 0 〉 = \vert x 〉}_{n} \{ \begin{matrix}\begin{matrix}\begin{matrix}{{( G ( \sqrt{x} ) \vert {ψ}_{0}^{′} 〉}_{n} \vert 0 〉}_{2} + \\ {{\sqrt{1 - {G ( \sqrt{x} )}^{2}} \vert {ψ}_{0}^{′} 〉}_{n} \vert {0}_{⊥} 〉}_{2} ) ,\end{matrix} & for odd d ,\end{matrix} \\ \begin{matrix}\begin{matrix}{( G ( \sqrt{x} ) \vert 0 〉}_{n + 2} + \\ {\sqrt{1 - {G ( \sqrt{x} )}^{2}} \vert {0}_{⊥} 〉}_{n + 2} ) ,\end{matrix} & for even d ,\end{matrix}\end{matrix} \qquad ( 9 )$$

With an appropriately chosen polynomial G which approximately performs

$$G ( \sqrt{x} ) \to \sqrt{\frac{A {e}^{x} - B}{C}} ,$$

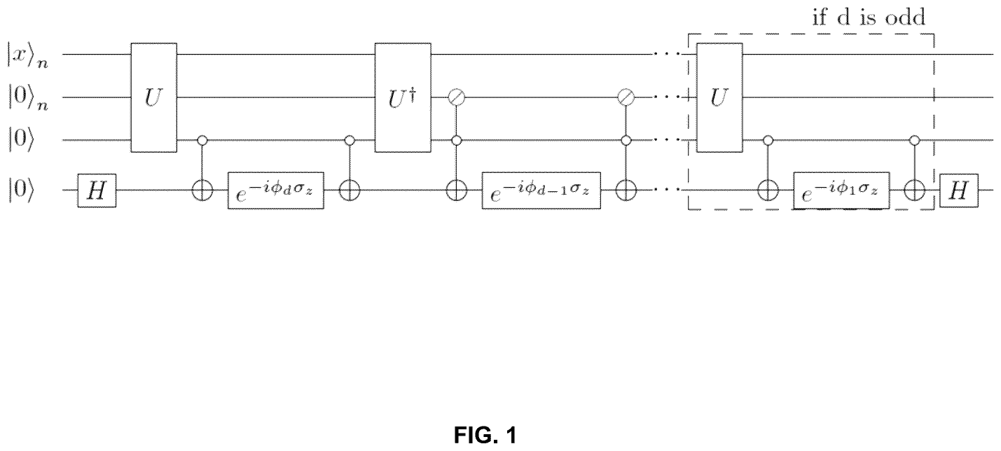

the unitary U₊^{\vec{ϕ}} can be used to approximately prepare the target state in Eq. (5). A circuit description of the operator U₊^{\vec{ϕ}} is shown in FIG. 1. After identifying a polynomial G to be applied with Quantum Signal Processing, the corresponding phase factors \vec{ϕ} for U₊^{\vec{ϕ}} can be calculated¹. ¹The corresponding phase factors may be calculated using the teachings of: Y. Dong, X. Meng, K. B. Whaley, and L. Lin. “Efficient phase-factor evaluation in quantum signal processing.” Physical Review A 103, 042419 (2021). Link: https://journals.aps.org/pra/abstract/10.1103/PhysRevA.103.042419

FIG. 1 is a circuit diagram of the U₊^{\vec{ϕ}} operator of Eq. (9) based on the unitary U of Eq. (4). The choice of angles \vec{ϕ}=(ϕ₁, ϕ₂, . . . , ϕ_{d}) determines the exact d-degree polynomial G applied to the state, such that the probability of measuring |00 [symbol] in the bottom two qubits if d is odd and |0 [symbol] in the bottom n+2 qubits if d is even, will be given by |G(\sqrt{x})|².

### Implementation

This section shows how to implement the unitary U of Eq. (4) and the choice of polynomial G used in Eq. (9) in order to construct the target state Eq. (5). This section assumes that the register |x [symbol] is an n-bit, binary, fixed-point representation of a scalar x with p digits to the left of the binary point

$$x = {\underbrace{{x}_{n - 1} … {x}_{n - p}}}_{p} \cdot {\underbrace{{x}_{n - p - 1} … {x}_{0}}}_{n - p} . \qquad ( 10 )$$

First consider the case where x is positive with p=0, such that x<1

$$x = {\sum }_{i = 0}^{N - 1} \frac{{x}_{i} \cdot {2}^{i}}{N} , \qquad ( 11 )$$

where xᵢ∈0, 1 denotes the i-th bit of |x [symbol] and N=2ⁿ. The first step to implement the transformation of Eq. (5) is to encode the value \sqrt{x} to the amplitude of an ancilla qubit. Start with the state |x [symbol] and apply Hadamard gates to n ancilla qubits to generate a uniform superposition:

$${{{{\vert x 〉}_{n} \vert + 〉}_{n} = {\sum }_{j = 0}^{N - 1} \frac{1}{\sqrt{N}} \vert x 〉}_{n} \vert j 〉}_{n} . \qquad ( 12 )$$

Then apply the following unitary operator

$$𝒞 : \vert a 〉 \vert b 〉 \vert 0 〉 \to \vert a 〉 \vert b 〉 \vert a < b 〉 \qquad ( 13 )$$

to perform a binary comparison² between the two qubit registers of Eq. (12), which produces the state ²An example for implementing the comparator operator [symbol] can be found at: T. G. Draper, S. A. Kutin, E. M. Rains, and K. M. Svore, “A logarithmic-depth quantum carry-lookahead adder,” Quantum Information and Computation 6, 351 (2006). Link: https://arxiv.org/abs/quant-ph/0406142

$${{{{{{\sum }_{j = 0}^{N - 1} \frac{1}{\sqrt{N}} \vert x 〉}_{n} \vert j 〉}_{n} \vert N \cdot x < j 〉 = \vert x 〉}_{n} ⊗ [ {\sum }_{j = 0}^{N \cdot x - 1} \frac{1}{\sqrt{N}} \vert j 〉}_{n} \vert 0 〉 + {\sum }_{j = N \cdot x}^{N - 1} \frac{1}{\sqrt{N}} \vert j 〉}_{n} \vert 1 〉 ] , \qquad ( 14 )$$

with x given by Eq. (11). The probability of measuring |0 [symbol] in the comparator ancilla qubit is then

$$\frac{N \cdot x}{N} = x .$$

The unitary U= [symbol] ( [symbol] ⊗H^{⊗n}⊗ [symbol] ) acting on the state |x [symbol] |0 [symbol] therefore creates the target state of Eq. (4)

$${{{{{U \vert x 〉}_{n} \vert 0 〉}_{n + 1} = \vert x 〉}_{n} ( \sqrt{x} \vert {ψ}_{0} 〉}_{n} \vert 0 〉 + \sqrt{1 - x} \vert {ψ}_{1} 〉}_{n} \vert 1 〉 ) , \qquad ( 15 )$$

where |ψ₀ [symbol] and |ψ₁ [symbol] n are normalized quantum states which depend on the value of x. A polynomial G which approximates the function

$$f ( x ) \to \sqrt{\frac{A {e}^{{x}^{2}} - B}{C}} , \qquad ( 16 )$$

in the domain x∈[0,1] allows approximate preparation of the target state given by Eq. (5) using Eq. (9).

When p>0 such that x≥1 (see Eqn. (10)), the unitary U as above may be used, ignoring the location of the binary point p, which in this case generates the state

$${{{{{U \vert x 〉}_{n} \vert 0 〉}_{n + 1} = \vert x 〉}_{n} ( \sqrt{\frac{x}{{2}^{p}}} \vert {ψ}_{0} 〉}_{n} \vert 0 〉 + \sqrt{1 - \frac{x}{{2}^{p}}} \vert {ψ}_{1} 〉}_{n} \vert 1 〉 ) . \qquad ( 17 )$$

Because of the extra factor of 2^{p}, the polynomial G in this case approximates the function

$$f ( x ) \to \sqrt{\frac{A {e}^{{x}^{2} \cdot {2}^{p}} - B}{C}} , \qquad ( 18 )$$

in order to generate the target state of Eq. (5).

In order to handle negative values of x, first pick a value s≥|x|≥0 and then apply a binary addition circuit which performs |x [symbol] |0 [symbol] →|x [symbol] |x+s [symbol] , where |x+s [symbol] is again a fixed-point register with m total digits and p to the left of the binary point (thus increasing the x values to all be zero or positive). The unitary U of Eq. (17) is then applied with the second register as input to construct the state

$${{{{{U \vert x + s 〉}_{m} \vert 0 〉}_{m + 1} = \vert x + s 〉}_{m} ( \sqrt{\frac{x + s}{{2}^{p}}} \vert {ψ}_{0} 〉}_{m} \vert 0 〉 + \sqrt{1 - \frac{x + s}{{2}^{p}}} \vert {ψ}_{1} 〉}_{m} \vert 1 〉 ) , \qquad ( 19 )$$

where the normalization factor 2^{p} arising from treating the fixed-point register |x+s [symbol] as a binary string in the comparator circuit, similarly handles the case x≤−1.0. The polynomial G which generates the target state of Eq. (5) approximates the function

$$\\ \begin{matrix}f ( x ) \to \sqrt{\frac{{Ae}^{{}_{} {x}^{{}_{} 2} \cdot {2}^{{}_{} p}} {e}^{{}_{} - s} - B}{C}} . & ( 20 )\end{matrix}$$

Note that for both positive and negative values of x, the transformation in Eq. (19) guarantees that the input to the polynomial G will only be the domain x∈[0,1]. This way, while only polynomials with definite parity (either even or odd) can be implemented using Quantum Signal Processing, the function being approximated with Quantum Signal Processing can be extended to the domain x∈[−1,1] using ƒ(−x)=ƒ(x) or ƒ(−x)=−ƒ(x), even if ƒ(x) does not have definite parity. Additionally, the unitary U of Eq. (19) and the function Eq. (20) allow construction of the target state for any input x, provided that ƒ(x)∈[0, 1].

### Application

This section describes how the descriptions in the previous sections to prepare the state in Eq. (5) can be used in derivative pricing to compute example payoffs of the form ƒ(S)=max(0, S−K), by considering a European call option. Given a strike price K, the holder of a European call option contract receives at a future date T (the expiration date) the amount

$$\\ \begin{matrix}f ( {S}_{T} ) = max ( 0 , {S}_{T} - K ) , & ( 21 )\end{matrix}$$

where S_{T} is the market price of an underlying asset (which is an example of an object) at date T. In order to determine the value of this contract today, the future price of the underlying asset is modeled as a stochastic variable with an appropriate probability distribution, and the price of the option is calculated by computing the expectation value of its payoff in Eq. (21).

An example re-parameterization method for derivative pricing³ implements the operator of Eq. (1) by loading a discretized normal distribution and then performing an affine transformation to the registers using quantum arithmetic to generate a superposition of possible log-returns rᵢ at time T, each weighed by the probability of occurrence ³For more details, see: S. Chakrabarti, R. Krishnakumar, G. Mazzola, N. Stamatopoulos, S. Woerner, and W. J. Zeng. “A Threshold for Quantum Advantage in Derivative Pricing,” Quantum 5, 463 (2021). Link: https://quantum-journal.org/papers/q-2021-06-01-463/

$$\\ \begin{matrix}{{\sum }_{i = 0}^{N - 1} \sqrt{{p}_{i}} \vert {r}_{i} 〉}_{n} , & ( 22 )\end{matrix}$$

where N=2ⁿ. In this example, the price of the underlying asset for each possible log-return rᵢ is then given by Sᵢ=S₀e^{r}^{ᵢ}, where S₀ is the price of the underlying asset today. The payoff operator of Eq. (2) is implemented by first calculating the price of the underlying asset from the log-return into another register

$$\\ \begin{matrix}{{\sum }_{i = 0}^{N - 1} \sqrt{{p}_{i}} \vert {r}_{i} 〉}_{n} \to {{\sum }_{i = 0}^{N - 1} \sqrt{{p}_{i}} \vert {r}_{i} 〉}_{n} \vert {S}_{i} = {S}_{0} {e}^{{}_{} {r}_{i}} 〉 , & ( 23 )\end{matrix}$$

computing the payoff of Eq. (21)

$$\\ \begin{matrix}{{{\sum }_{i = 0}^{N - 1} \sqrt{{p}_{i}} \vert {r}_{i} 〉}_{n} \vert {S}_{i} 〉 \to {\sum }_{i = 0}^{N - 1} \sqrt{{p}_{i}} \vert {r}_{i} 〉}_{n} \vert {S}_{i} 〉 \vert f ( {S}_{i} ) 〉 , & ( 24 )\end{matrix}$$

and finally encoding the payoff into the amplitude of an ancilla qubit

$$\\ \begin{matrix}{{{\sum }_{i = 0}^{N - 1} \sqrt{{p}_{i}} \vert {r}_{i} 〉}_{n} \vert {S}_{i} 〉 \vert f ( {S}_{i} ) 〉 \to {\sum }_{i = 0}^{N - 1} \sqrt{{p}_{i}} \vert {r}_{i} 〉}_{n} \vert {S}_{i} 〉 \vert f ( {S}_{i} ) 〉 ( \sqrt{\frac{max ( 0 , {S}_{i} - K )}{{f}_{max}}} \vert 0 〉 + \sqrt{\frac{1 - max ( 0 , {S}_{i} - K )}{{f}_{max}}} \vert 1 〉 ) , & ( 25 )\end{matrix}$$

where ƒₘₐₓ=e^{max{r}^{ᵢ}^{}}−K is the maximum value of the payoff possible by the discretization chosen in Eq. (22). The probability of measuring |0 [symbol] in the last qubit is

$$\\ \begin{matrix}ℙ [ \vert 0 〉 ] = {\sum }_{i = 0}^{N - 1} {p}_{i} \frac{max ( 0 , {S}_{i} - K )}{{f}_{max}} , & ( 26 )\end{matrix}$$

which is the expectation value of the option's payoff, normalized by ƒₘₐₓ. Thus, applying amplitude estimation to the last qubit estimates the price of the option.

However, the above example re-parameterization method requires explicit computation of the values |Sᵢ=S₀e^{r}^{ᵢ} [symbol] and |ƒ(Sᵢ) [symbol] using quantum arithmetic (e.g., computing these values digitally using qubits like classical bits and performing the same arithmetic logic as in a classical computing system), which is resource intensive. In contrast, the following paragraphs describe using the techniques described in previous sections to determine the price of the option without using quantum arithmetic to explicitly calculate these values.

Let the |rᵢ [symbol] register of Eq. (22) represent each log-return in fixed-point representation and let s=ln(S₀/K). Apply a circuit which performs the comparison |rᵢρ|0 [symbol] →|rᵢ [symbol] |rᵢ≤s [symbol] to Eq. (22) to get

$$\\ \begin{matrix}{{\sum }_{\{ i \vert {r}_{i} > s \}} \sqrt{{p}_{i}} \vert {r}_{i} 〉}_{n} \vert 0 〉 + {{\sum }_{\{ i \vert {r}_{i} \leq {}_{} s \}} \sqrt{{p}_{i}} \vert {r}_{i} 〉}_{n} \vert 1 〉 . & ( 27 )\end{matrix}$$

Add an m-qubit register and compute |rᵢρ|0 [symbol] →|rᵢ [symbol] |rᵢ+|s| [symbol] , where the second register is also a fixed-point representation and m is large enough to hold the maximum value of rᵢ+|s|, to get

$$\\ \begin{matrix}{{{\sum }_{\{ i \vert {r}_{i} > s \}} \sqrt{{p}_{i}} \vert {r}_{i} 〉}_{n} \vert {r}_{i} + \vert s \vert 〉}_{m} \vert 0 〉 + … , & ( 28 )\end{matrix}$$

where terms with the last qubit being in the |1 [symbol] state are ignored. Note that 0≤rᵢ+|s|<2^{p} if the register |rᵢ+|s| [symbol] has p digits to the left of the binary point. The application of the U operator of Eq. (19) to the |rᵢ+|s| [symbol] register and a new qubit register |0 [symbol] gives

$$\\ \begin{matrix}{{{{{\sum }_{\{ i \vert {r}_{i} > s \}} \sqrt{{p}_{i}} \vert {r}_{i} 〉}_{n} \vert {r}_{i} + \vert s \vert 〉}_{m} ( \sqrt{\frac{{r}_{i} + \vert s \vert}{{2}^{{}_{} p}}} \vert {ψ}_{0} 〉}_{m} \vert 0 〉 + \sqrt{1 - \frac{{r}_{i} + \vert s \vert}{{2}^{{}_{} p}}} \vert {ψ}_{1} 〉}_{m} \vert 1 〉 ) \vert 0 〉 , & ( 29 )\end{matrix}$$

for normalized quantum states |ψ₀ [symbol] and |ψ₁ [symbol] . Employing the Quantum Signal Processing unitary U₊^{\vec{ϕ}} of Eq. (9) with phases \vec{ϕ}=(ϕ₁, ϕ₂, . . . , ϕ_{d}) chosen such that the polynomial G approximates the function

$$\\ \begin{matrix}f ( x ) = \sqrt{\frac{{S}_{0} {e}^{{}_{} {x}^{{}_{} 2} \cdot {2}^{{}_{} p}} {e}^{{}_{} - \vert s \vert} - K}{{f}_{max}}} & ( 30 )\end{matrix}$$

produces

$$\\ \begin{matrix}{{{{\sum }_{\{ i \vert {r}_{i} > s \}} \sqrt{{p}_{i}} \vert {r}_{i} 〉}_{n} \vert {r}_{i} + \vert s \vert 〉}_{m} ( \sqrt{\frac{{S}_{0} {e}^{{}_{} {r}_{i}} - K}{{f}_{max}}} \vert {ψ}_{0}^{{}_{} ′} 〉}_{m} \vert B 〉 ) , & ( 31 )\end{matrix}$$

with |B [symbol] =|0 [symbol] for odd d, and

$$\\ \begin{matrix}{{{\sum }_{\{ i \vert {r}_{i} > s \}} \sqrt{{p}_{i}} \vert {r}_{i} 〉}_{n} \vert {r}_{i} + \vert s \vert 〉}_{m} ( \sqrt{\frac{{S}_{0} {e}^{{}_{} {r}_{i}} - K}{{f}_{max}}} \vert B 〉 ) , & ( 32 )\end{matrix}$$

with |B [symbol] =|0 [symbol] for even d, where terms with any qubit in the last register being in the |1 [symbol] state are ignored. Applying amplitude estimation to estimate the probability of measuring the |B [symbol] state gives

$$\\ \begin{matrix}ℙ [ \vert B 〉 ] = {\sum }_{\{ i \vert {r}_{i} > s \}} {p}_{i} \frac{{S}_{0} {e}^{{}_{} {r}_{i}} - K}{{f}_{max}} , & ( 33 )\end{matrix}$$

which is the same as the value estimated using the example re-parameterization method in Eq. (26). However, among other advantages, the method of equations 27-33 does not use quantum arithmetic to explicitly compute the values of |Sᵢ=S₀e^{r}^{ᵢ} [symbol] and |ƒ(Sᵢ) [symbol] , but instead these values are implicitly calculated by amplitude transformations using Quantum Signal Processing.

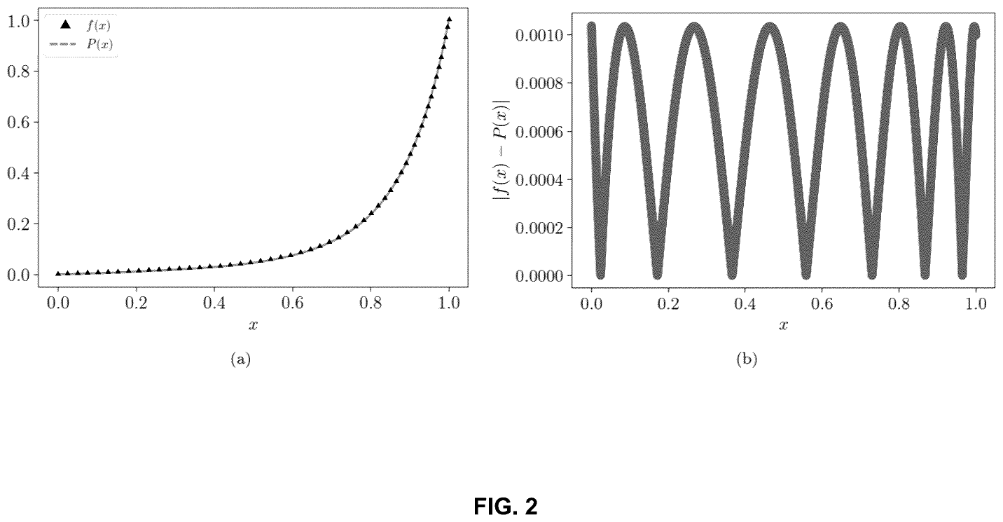

FIG. 2A is a plot of the function ƒ(x) of Eq. (30) used to compute the payoff of a European call option and d=16-degree approximating Chebyshev polynomial G(x), which can be applied to a quantum system using the Quantum Signal Processing unitary of Eq. (9). FIG. 2B is a plot of the absolute error between ƒ(x) and the approximation G(x). For both plots the following values were used: S₀=K=100 and p=3, giving ƒₘₐₓ=S₀e²^{^{p}}−K.

### Example Methods

Although previous descriptions provide examples methods for controlling a quantum computing system to determine the value of an object (e.g., determining the price of a financial derivative), the below paragraphs describe additional examples. The descriptions below may omit steps previously described and/or include steps that are in addition to or alternative to the steps previously described.

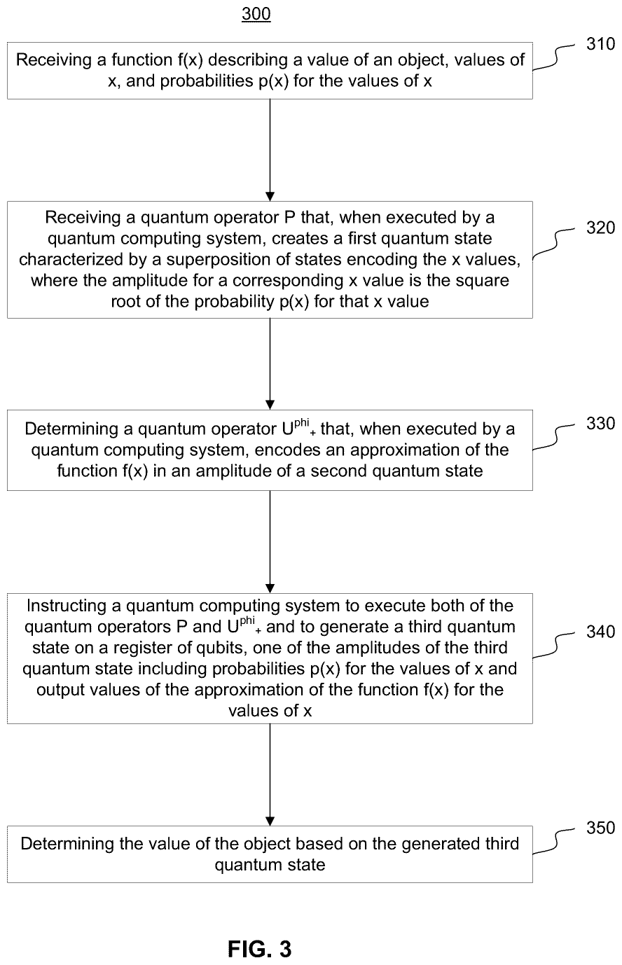

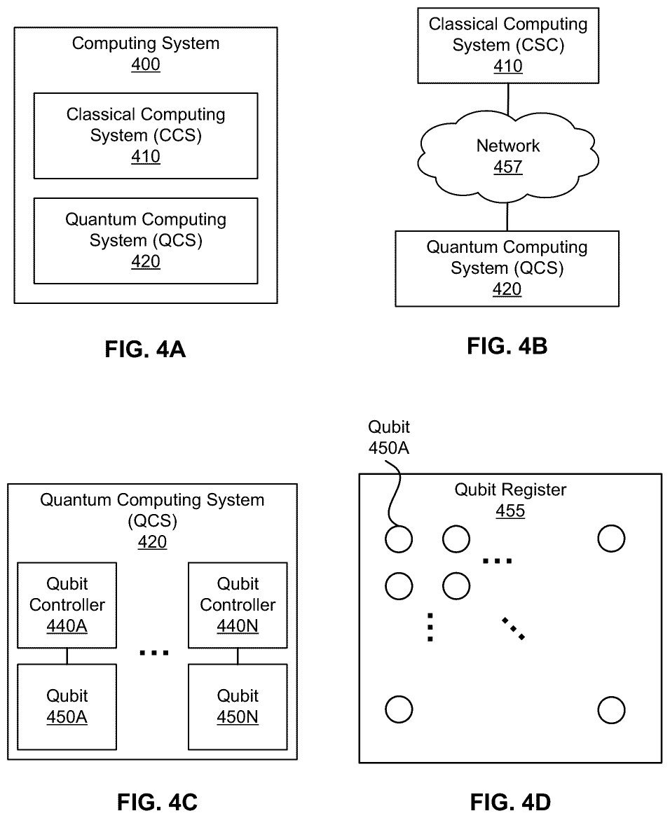

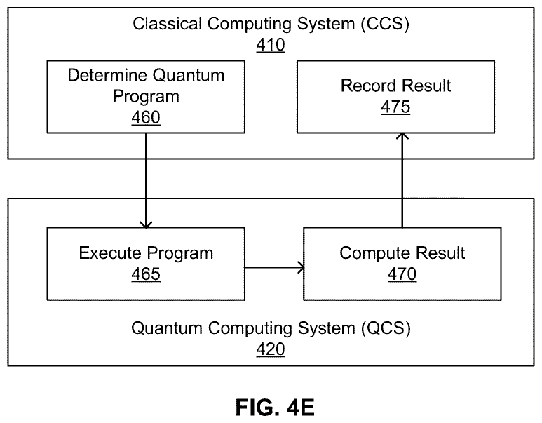

FIG. 3 is a flowchart of an example method 300 for controlling a quantum computing system to determine the value of an object (e.g., determining the price of a financial derivative). Note that the below description makes several references to FIG. 4, which is further described below. In the example of FIG. 3, the method 300 is performed from the perspective of a (e.g., classical) computing system (e.g., 410) that can instruct and/or control a quantum computing system (e.g., 420). The method 300 can include greater or fewer steps than described herein. Additionally, the steps can be performed in different order or by different components than described herein. In some embodiments, the method 300 is performed by the computing system executing code stored on a (e.g., non-transitory) computer-readable storage medium that causes the computing system to perform the steps of method 300.

At step 310, the computing system receives a function ƒ(x) describing a value of an object (which is an example of a quantity of the object), values of x, and probabilities p(x) for the values of x.

At step 320, the computing system receives (or determines) a quantum operator P (also “ [symbol] ”) that, when executed by a first quantum computing system (e.g., 420), creates a first quantum state characterized by a superposition of states encoding the x values, where the amplitude for a corresponding x value is the square root of the probability p(x) for that x value. The first quantum state may be a probability weighted superposition for all the values of x. For example, the first quantum state is given by Σₓ\sqrt{p(x)}|x [symbol] , where |x [symbol] is a quantum state on an n-qubit register storing an n-bit binary representation of the corresponding value of x. For additional information on the quantum operator P, see e.g., Eqns. (1) and (22) and associated descriptions (note that in Eqn. (1), the symbol ω is used instead of x).

At step 330, the computing system determines a quantum operator U₊^{\vec{ϕ}} (e.g., see Eqn. (9) and associated description) that, when executed by a quantum computing system (e.g., 420 or another quantum computing system), encodes an approximation of the function ƒ(x) in an amplitude of a second quantum state without calculating |ƒ(x) [symbol] for any of the values of x(|ƒ(x) [symbol] is a binary representation of an output value of ƒ(x) stored on qubits of a quantum register). Note that U₊^{\vec{ϕ}} in FIG. 3 is represented by the following symbol: U^{phi}₊. The approximation of the function ƒ(x) is within an error threshold of the function ƒ(x). In general, to decrease the approximation error, the computational resources are increased. Thus, the error of the approximation may be based on the available resources and the error target threshold of the value for the object being determined.

Steps 310, 320, and 330 may be part of example step 460 in FIG. 4E.

At step 340, the computing system controls (e.g., instructs) a third quantum computing system (e.g., 420 or another quantum computing system) to execute both of the quantum operators P and U₊^{\vec{ϕ}} to generate a third quantum state on a register of qubits. One of the amplitudes of the third quantum state includes probabilities p(x) for the values of x and output values of the function ƒ(x) for the values of x. Instructing the third quantum computing system to execute both of the quantum operators P and U₊^{\vec{ϕ}} includes instructing the third quantum computing system to execute the quantum operator P prior to executing the quantum operator U₊^{\vec{ϕ}}.

In some aspects, the one of the amplitudes of the third quantum state is the square root of the weighted average of ƒ(x) for the x values where the weights are the probabilities p(x) for the corresponding values of x. Said differently, the one of the amplitudes is Σₓ\sqrt{p(x)}\sqrt{ƒ(x)} (which means the probability of measuring the state associated with the one of the amplitudes is [symbol] [ƒ]=Σₓp(x)ƒ(x)).

Step 340 may be part of example step 465 in FIG. 4E.

At step 350, the computing system determines the value of the object based on the generated third quantum state.

Step 350 may be part of example step 475 in FIG. 4E.

In some aspects, the method 300 does not include calculating |ƒ(x) [symbol] .

In some aspects, the method 300 further includes determining s, where s is based on the absolute values of the x values; and instructing the third quantum computing system to apply a quantum binary addition circuit that performs the operation: |x [symbol] |0 [symbol] →|x [symbol] |x+s [symbol] , where n and m are integers greater than zero, m>n, |x [symbol] is a quantum state on an n-qubit register storing an n-bit binary representation of a value of x, and |x+s [symbol] is a quantum state on an m-qubit register storing a representation of a value of x+s with m total digits and p digits to the left of the binary point. In some aspects, s is based on the upper bound of the absolute values of the x values (e.g., s≥|x|≥0). For example, s is the absolute value of the smallest x value of the values of x (however, s may be larger than this). For example, if the x values range from 4 to −5, then s=5.

In some aspects, the quantum binary addition circuit is executed subsequent to execution of the quantum operator P but prior to execution of the quantum operator U₊^{\vec{ϕ}}.

For additional information on s and the quantum binary addition circuit, see e.g., Eqns. (18)-(19) and (27)-(29) and their associated descriptions.

In some aspects, determining the quantum operator U₊^{\vec{ϕ}}, includes generating an if initial quantum operator given by U=C( [symbol] ⊗H^{⊗m}⊗ [symbol] ), where C is a comparator quantum circuit defined by C:|a [symbol] |b [symbol] |0 [symbol] →|a [symbol] |b [symbol] |a<b [symbol] , I is an identity matrix, and H is a Hadamard gate. For more information on the initial quantum operator U, see Eqns. (10)-(15) and their associated descriptions.

In some aspects, determining the quantum operator U₊^{\vec{ϕ}} further includes applying the initial quantum operator U to state |x+s [symbol] |0 [symbol] to generate the following quantum state:

$${{{{{\\ U \vert x + s 〉}_{m} \vert 0 〉}_{m + 1} = \vert x + s 〉}_{m} ( \sqrt{\frac{x + s}{{2}^{{}_{} p}}} \vert {ψ}_{0} 〉}_{m} \vert 0 〉 + \sqrt{1 - \frac{x + s}{{2}^{{}_{} p}}} \vert {ψ}_{1} 〉}_{m} \vert 1 〉 ) , where$$

$${{\\ \vert {ψ}_{0} 〉}_{m} and \vert {ψ}_{1} 〉}_{m}$$

are normalized quantum states. For more information, see Eqn. (4)-(5) and (15)-(19) and their associated descriptions.

In some aspects, determining the quantum operator U₊^{\vec{ϕ}} includes performing a Quantum Signal Processing (QSP) algorithm. Performing the QSP algorithm may include determining phase parameters representing a polynomial approximation that approximates

$$\sqrt{\frac{A {e}^{( {x}^{2} \cdot {2}^{p} )} {e}^{- s} - B}{C}} ,$$

where A, B, and C are constants: (1) based on the function ƒ(x) and (2) that satisfy

$$\frac{A {e}^{( {x}^{2} \cdot {2}^{p} )} {e}^{- s} - B}{C} ∈ [ 0 , 1 ] .$$

For more information, see Eqns. (20) and (3) and their associated descriptions. The approximation error of the polynomial approximation may be within a target error threshold of the target function (which in this case is

$$\sqrt{\frac{A {e}^{( {x}^{2} \cdot {2}^{p} )} {e}^{- s} - B}{C}} ) .$$

In general, to decrease the approximation error, the degree of the polynomial is increased, which increases the computational resources to perform the calculation. Thus, the error of the polynomial approximation may be based on the available resources and the error target threshold for the value of the object being determined.

In some aspects, the function ƒ(x) is a normalized function with output values ranging from zero to one.

In some aspects, the value (an example of a quantity of the object) of the object fluctuates stochastically.

In some aspects, determining the value of the object based on the generated quantum state includes performing an amplitude estimation algorithm to determine value of the object.

Some aspects relate to new example method including: instructing (e.g., by a classical computing system 410) a quantum computing system (e.g., 420) to execute a quantum operator that prepares an approximation to a target quantum state given by:

$${{{{{{{\vert x 〉}_{n} \vert 0 〉}_{n + a} \to \vert x 〉}_{n} ( \sqrt{\frac{A {e}^{x} - B}{C}} \vert {ψ}_{0}^{′} 〉}_{n} \vert 0 〉}_{a} + \sqrt{1 - \frac{A {e}^{x} - B}{C}} \vert {ψ}_{1}^{′} 〉}_{n} \vert {0}_{⊥} 〉}_{a} ) ,$$

where x is a scalar number; |x [symbol] is a quantum state on an n-qubit register of the quantum computing system storing an n-bit binary representation of x; n and a are integers greater than zero; |ψ₀′ [symbol] and |ψ₀′ [symbol] are normalized quantum states; |0_{⊥} [symbol] is a normalized quantum state orthogonal to |0 [symbol] ; A, B, and C are constants such that (Ae^{x}−B)/C∈[0, 1]; and the approximation is within an error threshold of

$$\sqrt{\frac{A {e}^{x} - B}{C}} .$$

In some aspects, the quantum computing system executes the quantum operator on a register of qubits.

Other aspects include components, devices, systems, improvements, methods, processes, applications, computer readable mediums, and other technologies related to any of the above.

### Quantum Signal Processing

This section provides a general description of Quantum Signal Processing (QSP). QSP is a technique which performs polynomial transformations to the singular values of a matrix A that has been block-encoded into a unitary operator. Specifically, given projectors Π and \tilde{Π}, a unitary U acting on n qubits is a block-encoding of a matrix A if A=\tilde{┌}UΠ, such that the projectors Π and \tilde{Π} determine the location of A in U

$$U = \begin{matrix} & Π \\ \tilde{Π} & [ \begin{matrix}A & \cdot \\ \cdot & \cdot \end{matrix} ] . \\ & \end{matrix} \qquad ( 34 )$$

QSP includes consecutive applications of U and U^{†}, interleaved with projector-controlled rotation operators Π_{ϕ}= [symbol] and \tilde{Π}_{ϕ}= [symbol] , which for phase factors \vec{ϕ}=(ϕ₁, ϕ₂, . . . , ϕ_{d}) induce a polynomial transformation on A such that

$$A = {\sum }_{k} {σ}_{k} \vert {w}_{k} 〉 〈 {v}_{k} \vert \to G ( A ) = {\sum }_{k} G ( {σ}_{k} ) \vert {w}_{k} 〉 〈 {v}_{k} \vert , \qquad ( 35 )$$

where σₖ denote the singular values of A while {|wₖ [symbol] }, {|vₖ [symbol] } are the left and right singular vectors of A respectively, and G is a d-degree polynomial. When A is Hermitian, in which case the singular values of the matrix coincide with its eigenvalues, Quantum Signal Processing effectively performs a polynomial transformation to the eigenvalues of the matrix.

More formally, define the operators

$${u}^{\vec{ϕ}} = \{ \begin{matrix}{\tilde{\prod }}_{{ϕ}_{1}} U {\prod }_{k = 1}^{( d - 1 ) / 2} {\prod }_{{ϕ}_{2 k}} {U}^{†} {\tilde{\prod }}_{{ϕ}_{2 k + 1}} U , for odd d , \\ {\prod }_{k = 1}^{d / 2} {\prod }_{{ϕ}_{2 k - 1}} {U}^{†} {\tilde{\prod }}_{{ϕ}_{2 k}} U , for even d\end{matrix} \qquad ( 36 )$$

$${u}_{C}^{\vec{ϕ}} = ( {u}^{\vec{ϕ}} ⊗ \vert 0 〉 〈 0 \vert + {u}^{- \vec{ϕ}} ⊗ \vert 1 〉 〈 1 \vert ) . \qquad ( 37 )$$

If U is an n-qubit unitary, the polynomial transformation achieved through QSP is implemented with

$${U}^{\vec{ϕ}} = ( {{}^{⊗} n}^{} ⊗ H ) {u}_{C}^{\overline{ϕ}} ( {{}^{⊗} n}^{} ⊗ H ) = \begin{matrix} & Π \\ {Π}^{′} & [ \begin{matrix}G ( A ) & \cdot \\ \cdot & \cdot \end{matrix} ] \\ & \end{matrix} \qquad ( 38 )$$

where Π′=\tilde{Π} for odd d and \tilde{Π}′=Π for even d.

In practice, d invocations of U perform a d-degree polynomial transformation to A and the choice of phase factors \vec{ϕ}=(ϕ₁, ϕ₂, . . . , ϕ_{d}) determine the exact polynomial that is applied. Remarkably, the reverse is also true: for a∈[−1, 1] and any real polynomial G∈ [symbol] (a), there exists a sequence of QSP phase factors \vec{ϕ}=(ϕ₁, ϕ₂, . . . , ϕ_{d}) for which Eqn. (38) holds, as long as deg(G)≤d, |P(a)|≤1, ∀a∈[−1, 1], and G either even or odd. Additionally, for any function ƒ(a) satisfying these conditions a polynomial approximation to the function can be identified, the QSP phase factors \vec{ϕ} for that polynomial can be determined, and QSP used to approximately apply ƒ(a) to the singular values of the block-encoded matrix. Various methods have been proposed to generate polynomial approximations to generic functions, where the approximation is either constructed analytically or with optimization-based numerical methods.

### Description of a Computing System

Embodiments described above may be implemented using one or more computing systems. Example computing systems are described below.

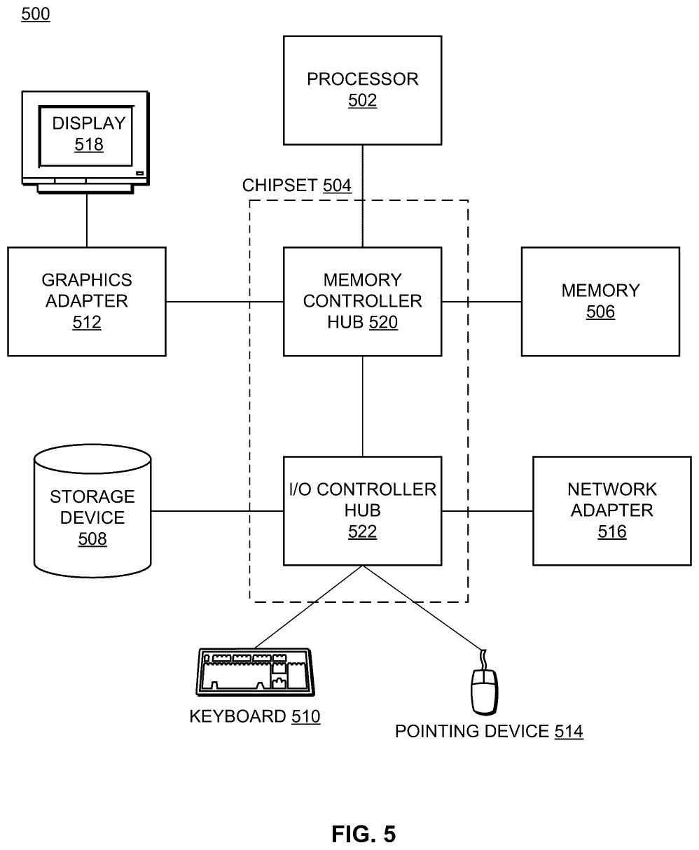

FIG. 4A is a block diagram that illustrates an embodiment of a computing system 400. In the example of FIG. 4A, the computing system 400 includes a classical computing system 410 (also referred to as a non-quantum computing system) and a quantum computing system 420, however a computing system may just include a classical computing system or a quantum computing system. An embodiment of the classical computing system 410 is described further with respect to FIG. 5. While the classical computing system 410 and quantum computing system 420 are illustrated together, they may be physically separate systems. For example, FIG. 4B illustrates an example cloud computing architecture where the computing system 410 and the quantum computing system 420 communicate via a network 457. The computing system 400 may include different or additional elements than illustrated (e.g., multiple quantum computing systems 420).

The classical computing system 410 may control the quantum computing system 420. For example, the classical computing system 410 generates and transmits instructions for the quantum computing system 420 to execute a quantum algorithm or quantum circuit. Although only one classical computing system 410 is illustrated in FIG. 4A, any number of classical computing system 410 or other external systems may be connected to the quantum computing system 420.

FIG. 4C is a block diagram that illustrates an embodiment of the quantum computing system 420. The quantum computing system 420 includes any number of quantum bits (“qubits”) 450 and associated qubit controllers 440. As illustrated in FIG. 4D, the qubits 450 may be in a qubit register of the quantum computing system 420 (or multiple registers). Qubits are further described below. A qubit controller 440 is a module that controls one or more qubits 450. A qubit controller 440 may include one or more classical processors such as one or more CPUs, one or more GPUs, one or more FPGAs, or some combination thereof. A qubit controller 440 may perform physical operations on one or more qubits 450 (e.g., it can perform quantum gate operations on a qubit 440). In the example of FIG. 4C, a separate qubit controller 440 is illustrated for each qubit 450, however a qubit controller 450 may control multiple (e.g., all) qubits 450 of the quantum computing system 420 or multiple controllers 450 may control a single qubit. For example, the qubit controllers 450 can be separate processors, parallel threads on the same processor, or some combination of both.

FIG. 4E is a flow chart that illustrates an example execution of a quantum routine on the computing system 400. The classical computing system 410 generates 460 a quantum program to be executed or processed by the quantum computing system 420. The quantum program may include instructions or subroutines to be performed by the quantum computing system 420. In an example, the quantum program is a quantum circuit. The quantum computing system 420 executes 465 the program and computes 470 a result (referred to as a shot or run). Computing the result may include performing a measurement of a quantum state generated by the quantum computing system 420 that resulted from executing the program. Practically, this may be performed by measuring values of one or more of the qubits 450. The quantum computing system 420 typically performs multiple shots to accumulate statistics from probabilistic execution. The number of shots and any changes that occur between shots (e.g., parameter changes) may be referred to as a schedule. The schedule may be specified by the program. The result (e.g., quantum state data) (or accumulated results) is recorded 475 by the classical computing system 410. Results may be returned after a termination condition is met (e.g., a threshold number of shots occur). The classical computing system 410 may determine a quantity based on the received results.

The quantum computing system 420 exploits the laws of quantum mechanics in order to perform computations. A quantum processing device (QPU), a quantum computer, a quantum processor system, and a quantum processing unit are each examples of a quantum computing system. The quantum computing system 420 can be a universal or a non-universal quantum computing system (a universal quantum computing system can execute any possible quantum circuit (subject to the constraint that the circuit doesn't use more qubits than the quantum computing system)). In some embodiments, the quantum computing system 420 is a gate model quantum computer. As previously described, quantum computing systems use so-called qubits, or quantum bits (e.g., 450A). While a classical bit always has a value of either 0 or 1, a qubit is a quantum mechanical system that can have a value of 0, 1, or a superposition of both values. Example physical implementations of qubits include superconducting qubits, spin qubits, trapped ions, arrays of neutral atoms, and photonic systems (e.g., photons in waveguides). For the purposes of this disclosure, a qubit may be realized by a single physical qubit or as an error-protected logical qubit that itself comprises multiple physical qubits. Additionally, the disclosure is not specific to qubits. The disclosure may be generalized to apply to quantum computing systems 420 whose building blocks are qudits (d-level quantum systems, where d>2) or quantum continuous variables, rather than qubits.

A quantum operator (e.g., U₊^{\vec{ϕ}} or P) may be one or more quantum circuits. A quantum circuit is an ordered collection of one or more gates. A sub-circuit may refer to a circuit that is a part of a larger circuit. A gate represents a physical unitary operation performed on one or more qubits (e.g., changing the state of a qubit from 0 to 1 or creating a superposition of 0 and 1). Quantum gates may be described using unitary matrices. The depth of a quantum circuit is the least number of steps used to execute the circuit on a quantum computing system (e.g., 420). The depth of a quantum circuit may be smaller than the total number of gates because gates acting on non-overlapping subsets of qubits may be executed in parallel. A layer of a quantum circuit may refer to a step of the circuit, during which multiple gates may be executed in parallel. In some embodiments, a quantum circuit is executed by a quantum computing system. In this sense, a quantum circuit can be thought of as comprising a set of instructions or operations that a quantum computing system can execute. To execute a quantum circuit on a quantum computing system, a user may inform the quantum computing system what circuit is to be executed. A quantum computing system may include both a core quantum device and a classical peripheral/control device (e.g., a qubit controller 440) that is used to orchestrate the control of the quantum device. It is to this classical control device that the description of a quantum circuit may be sent when one seeks to have a quantum computer execute a circuit.

The parameters of a parameterized quantum circuit may refer to parameters of the gates. For example, a gate that performs a rotation about the y axis may be parameterized by a real number that describes the angle of the rotation.

The description of a quantum circuit to be executed on one or more quantum computing systems may be stored in a non-transitory computer-readable storage medium. The term “computer-readable storage medium” should be taken to include a single medium or multiple media (e.g., a centralized or distributed database, or associated caches and servers) able to store instructions. The term “computer-readable medium” shall also be taken to include any medium that is capable of storing instructions for execution by the quantum computing system and that cause the quantum computing system to perform any one or more of the methodologies disclosed herein. The term “computer-readable medium” includes, but is not limited to, data repositories in the form of solid-state memories, optical media, and magnetic media.

FIG. 5 is an example architecture of an example classical computing system 500 (e.g., 410). The quantum computing system 420 may also have one or more components described with respect to FIG. 5. FIG. 5 depicts a high-level block diagram illustrating physical components of a classical computing system used as part or all of one or more entities described herein, in accordance with an embodiment. A classical computing system may have additional, less, or variations of the components provided in FIG. 5. Although FIG. 5 depicts a classical computing system 500, the figure is intended as functional description of the various features which may be present in computing systems than as a structural schematic of the implementations described herein. In practice, and as recognized by those of ordinary skill in the art, items shown separately could be combined and some items could be separated.

Illustrated in FIG. 5 are a processor 502 coupled to a chipset 504. Also coupled to the chipset 504 are a memory 506, a storage device 508, a keyboard 510, a graphics adapter 512, a pointing device 514, and a network adapter 516. Although only a single processor 502 is illustrated in FIG. 5, the classical computing system 500 may include multiple processors capable of working individually or collectively to perform a process (e.g., one or more steps of method 300). A display 518 is coupled to the graphics adapter 512. In one embodiment, the functionality of the chipset 504 is provided by a memory controller hub 520 and an I/O hub 522. In another embodiment, the memory 506 is coupled directly to the processor 502 instead of the chipset 504. In some embodiments, the computer 500 includes one or more communication buses for interconnecting these components. The one or more communication buses optionally include circuitry (sometimes called a chipset) that interconnects and controls communications between system components.

The storage device 508 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 508 can also be referred to as persistent memory. The pointing device 514 may be a mouse, track ball, or other type of pointing device, and is used in combination with the keyboard 510 to input data into the computer 500. The graphics adapter 512 displays images and other information on the display 518. The network adapter 516 couples the computer 500 to a local or wide area network.

The memory 506 holds instructions and data used by the processor 502. The memory 506 can be non-persistent memory, examples of which include high-speed random access memory, such as DRAM, SRAM, DDR RAM, ROM, EEPROM, flash memory.

As is known in the art, a computer 500 can have different or other components than those shown in FIG. 5. In addition, the computer 500 can lack certain illustrated components. In one embodiment, a computer 500 acting as a server may lack a keyboard 510, pointing device 514, graphics adapter 512, or display 518. Moreover, the storage device 508 can be local or remote from the computer 500 (such as embodied within a storage area network (SAN)).

As is known in the art, the computer 500 is adapted to execute computer program modules for providing functionality described herein. As used herein, the term “module” refers to computer program logic utilized to provide the specified functionality. Thus, a module can be implemented in hardware, firmware, or software. In one embodiment, program modules are stored on the storage device 508, loaded into the memory 506, and executed, individually or together, by one or more processors (e.g., 502).

### Additional Considerations

The disclosure above describes example embodiments for purposes of illustration only. Any features that are described as essential, important, or otherwise implied to be required should be interpreted as only being required for that embodiment and are not necessarily included in other embodiments.

Some portions of above disclosure describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution, individually or together, by one or more processors, equivalent electrical circuits, microcodes, or the like. Furthermore, it has also proven convenient at times, to refer to these arrangements of functional operations as modules, without loss of generality. In some cases, a module can be implemented in hardware, firmware, or software.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

Alternative embodiments are implemented in computer hardware, firmware, software, and/or combinations thereof. Implementations can be implemented in a computer program product tangibly embodied in a machine-readable storage device for execution by a programmable processor system including one or more processors that can act individually or together; and method steps can be performed by a programmable processor system executing a program of instructions to perform functions by operating on input data and generating output. Embodiments can be implemented advantageously in one or more computer programs that are executable on a programmable system including one or more programmable processors coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Although the above description contains many specifics, these should not be construed as limiting the scope of the disclosure but merely as illustrating different examples. It should be appreciated that the scope of the disclosure includes other embodiments not discussed in detail above. Various other modifications, changes, and variations which will be apparent to those skilled in the art may be made in the arrangement, operation, and details of the methods and apparatuses disclosed herein without departing from the spirit and scope of the disclosure.

What is claimed is:

1. A method comprising:
receiving a function ƒ(x) describing a value of an object, values of x, and probabilities p(x) for the values of x;
receiving a quantum operator P that, when executed by a first quantum computing system, creates a first quantum state characterized by a superposition of states encoding the x values, where the amplitude for a corresponding x value is the square root of the probability p(x) for that x value;
determining a quantum operator U₊^{\vec{ϕ}} that, when executed by a second quantum computing system, encodes an approximation of the function ƒ(x) in an amplitude of a second quantum state without calculating |ƒ(x) [symbol] for any of the values of x, the approximation being within an error threshold of the function ƒ(x);
instructing a third quantum computing system to execute both of the quantum operators P and U₊^{\vec{ϕ}} to generate a third quantum state on a register of qubits, one of the amplitudes of the third quantum state including probabilities p(x) for the values of x and output values of the approximation of the function ƒ(x) for the values of x; and
determining the value of the object based on the generated third quantum state.

2. The method of claim 1, wherein the method does not include calculating |ƒ(x) [symbol] .

3. The method of claim 1, wherein the one of the amplitudes of the third quantum state is the square root of the weighted average of the approximation of the function ƒ(x) for the x values where the weights are the probabilities p(x) for the corresponding values of x.

4. The method of claim 1, wherein the first quantum state is given by Σₓ\sqrt{p(x)}|x [symbol] , where |x [symbol] is a quantum state on an n-qubit register storing an n-bit binary representation of the corresponding value of x.

5. The method of claim 1, further comprising:
determining s, where s is based on the absolute values of the x values; and
instructing the third quantum computing system to apply a quantum binary addition circuit that performs the operation: |x [symbol] |0 [symbol] →|x [symbol] |x+s [symbol] , where n and m are integers greater than zero, m>n, |x [symbol] is a quantum state on an n-qubit register storing an n-bit binary representation of a value of x, and |x+s [symbol] is a quantum state on an m-qubit register storing a representation of a value of x+s with m total digits and p digits to the left of the binary point.

6. The method of claim 5, wherein s is the absolute value of the smallest x value of the values of x.

7. The method of claim 1, wherein determining the quantum operator U₊^{\vec{ϕ}}, comprises generating an initial quantum operator given by U=C( [symbol] ⊗H^{⊗m}⊗ [symbol] ), where C is a comparator quantum circuit defined by C:|a [symbol] |b [symbol] |0 [symbol] →|a [symbol] |b [symbol] |a<b [symbol] , [symbol] is an identity matrix, and H is a Hadamard gate.

8. The method of claim 7, wherein determining the quantum operator U₊^{\vec{ϕ}} further comprises applying the initial quantum operator U to state |x+s [symbol] |0 [symbol] ₘ₊₁ to generate the following quantum state:
$${{{{{U \vert x + s 〉}_{m} \vert 0 〉}_{m + 1} = \vert x + s 〉}_{m} ( \sqrt{\frac{x + s}{{2}^{p}}} \vert {ψ}_{0} 〉}_{m} \vert 0 〉 + \sqrt{1 - \frac{x + s}{{2}^{p}}} \vert {ψ}_{1} 〉}_{m} \vert 1 〉 ) ,$$
where |ψ₀ [symbol] and |ψ₁ [symbol] are normalized quantum states.

9. The method of claim 8, wherein determining the quantum operator U₊^{\vec{ϕ}} further comprises performing a quantum signal processing (QSP) algorithm.

10. The method of claim 9, wherein performing the QSP algorithm includes determining phase parameters representing a polynomial approximation that approximates
$$\sqrt{\frac{A {e}^{( {x}^{2} \cdot {2}^{p} )} {e}^{- s} - B}{C}} ,$$
where A, B, and C are constants: (1) based on the function ƒ(x) and (2) that satisfy
$$\frac{A {e}^{( {x}^{2} \cdot {2}^{p} )} {e}^{- s} - B}{C} ∈ [ 0 , 1 ] .$$

11. A non-transitory computer readable storage medium storing instruction that, when executed by a computing system, cause the computing system to perform operations comprising:
receiving a function ƒ(x) describing a value of an object, values of x, and probabilities p(x) for the values of x;
receiving a quantum operator P that, when executed by a first quantum computing system, creates a first quantum state characterized by a superposition of states encoding the x values, where the amplitude for a corresponding x value is the square root of the probability p(x) for that x value;
determining a quantum operator U₊^{\vec{ϕ}} that, when executed by a second quantum computing system, encodes an approximation of the function ƒ(x) in an amplitude of a second quantum state without calculating |ƒ(x) [symbol] for any of the values of x, the approximation being within an error threshold of the function ƒ(x);
instructing a third quantum computing system to execute both of the quantum operators P and U₊^{\vec{ϕ}} to generate a third quantum state on a register of qubits, one of the amplitudes of the third quantum state including probabilities p(x) for the values of x and output values of the approximation of the function ƒ(x) for the values of x; and
determining the value of the object based on the generated third quantum state.

12. The non-transitory computer readable storage medium of claim 11, wherein the operations do not include calculating |ƒ(x) [symbol] .

13. The non-transitory computer readable storage medium of claim 11, wherein the one of the amplitudes of the third quantum state is the square root of the weighted average of the approximation of the function ƒ(x) for the x values where the weights are the probabilities p(x) for the corresponding values of x.

14. The non-transitory computer readable storage medium of claim 11, wherein the first quantum state is given by Σₓ\sqrt{p(x)}|x [symbol] , where |x [symbol] is a quantum state on an n-qubit register storing an n-bit binary representation of the corresponding value of x.

15. The non-transitory computer readable storage medium of claim 11, wherein the operations further comprise:
determining s, where s is based on the absolute values of the x values; and
instructing the third quantum computing system to apply a quantum binary addition circuit that performs the operation: |x [symbol] |0 [symbol] →|x [symbol] |x+s [symbol] , where n and m are integers greater than zero, m>n, |x [symbol] is a quantum state on an n-qubit register storing an n-bit binary representation of a value of x, and |x+s [symbol] is a quantum state on an m-qubit register storing a representation of a value of x+s with m total digits and p digits to the left of the binary point.

16. The non-transitory computer readable storage medium of claim 15, wherein s is the absolute value of the smallest x value of the values of x.

17. The non-transitory computer readable storage medium of claim 11, wherein determining the quantum operator U₊^{\vec{ϕ}}, comprises generating an initial quantum operator given by U=C( [symbol] ⊗H^{⊗m}⊗ [symbol] ), where C is a comparator quantum circuit defined by C:|a [symbol] |b [symbol] |0 [symbol] →|a [symbol] |b [symbol] |a<b [symbol] , [symbol] is an identity matrix, and His a Hadamard gate.

18. The non-transitory computer readable storage medium of claim 17, wherein determining the quantum operator U₊^{\vec{ϕ}} further comprises applying the initial quantum operator U to state |x+s [symbol] |0 [symbol] to generate the following quantum state:
$${{{{{U \vert x + s 〉}_{m} \vert 0 〉}_{m + 1} = \vert x + s 〉}_{m} ( \sqrt{\frac{x + s}{{2}^{p}}} \vert {ψ}_{0} 〉}_{m} \vert 0 〉 + \sqrt{1 - \frac{x + s}{{2}^{p}}} \vert {ψ}_{1} 〉}_{m} \vert 1 〉 ) ,$$
where |ψ₀ [symbol] and |ψ₁ [symbol] are normalized quantum states.

19. The non-transitory computer readable storage medium of claim 18, wherein determining the quantum operator U₊^{\vec{ϕ}} further comprises performing a quantum signal processing (QSP) algorithm.

20. The non-transitory computer readable storage medium of claim 19, wherein performing the QSP algorithm includes determining phase parameters representing a polynomial approximation that approximates
$$\sqrt{\frac{A {e}^{( {x}^{2} \cdot {2}^{p} )} {e}^{- s} - B}{C}} ,$$
where A, B, and C are constants: (1) based on the function ƒ(x) and (2) that satisfy
$$\frac{A {e}^{( {x}^{2} \cdot {2}^{p} )} {e}^{- s} - B}{C} ∈ [ 0 , 1 ] .$$
